(19) United States
(12) Patent Application Publication
(10) Pub. No.: US 2022/0110042 A1
(43) Pub. Date: Apr. 7, 2022

(54) V2X NETWORK HANDOVER SYSTEM AND METHOD THEREOF

(71) Applicants: HYUNDAI MOTOR COMPANY, Seoul (KR); KIA CORPORATION, Seoul (KR)

(72) Inventors: Jun Yeon PARK, Gunpo-si (KR); David OH, Yongin-si (KR); Jihoon PARK, Suwon-si (KR)

(73) Assignees: HYUNDAI MOTOR COMPANY, Seoul (KR); KIA CORPORATION, Seoul (KR)

(21) Appl. No.: 17/410,457

(22) Filed: Aug. 24, 2021

(30) Foreign Application Priority Data
Oct. 5, 2020 (KR) 10-2020-0127853

(51) Int. Cl. H04W 36/32; H04W 36/00; H04W 4/44; H04W 4/23

(52) U.S. Cl. CPC H04W 36/32; H04W 4/23; H04W 4/44; H04W 36/00837

(57) ABSTRACT

A V2X network handover system supporting autonomous driving of an unmanned transport vehicle may include, a plurality of RSUs disposed in a production plant, each being configured to broadcast a WSA message in a service area, and an OBU installed in the unmanned transport vehicle to transmit and receive V2X communication data through an integrated antenna and configured to obtain vehicle position information based on GNSS, where the OBU may be configured to execute a handover determination algorithm from the WSA message received in a service overlap area of a plurality of RSUs to select a handover target RSU based on an integrated condition combined with two or more among a distance-based condition based on a distance between each RSU and the unmanned transport vehicle, a weighted moving average condition of received signal strength indication (RSSI), and a data normal reception count condition.

### CROSS-REFERENCE TO RELATED APPLICATION

This application claims priority to and the benefit of Korean Patent Application No. 10-2020-0127853, filed on Oct. 5, 2020, the entire contents of which are incorporated herein by reference.

### TECHNICAL FIELD

The present disclosure relates to a V2X network handover system and a method thereof.

### BACKGROUND

The statements in this section merely provide background information related to the present disclosure and may not constitute prior art.

In general, in accordance with the expansion of the application of mobility operating facility, production plant is built with a vehicle-to-everything (V2X) network, and operates a vehicle for unattended transfer of component parts, manpower, and the like.

The V2X network includes RSUs (which may be also called a road side unit (RSU) hereinafter) disposed at preset spacings along a road and supports infrastructure communication for supporting autonomous driving of the unattended vehicle. The vehicle equipped with an on-board unit (OBU) (which may be called a vehicle terminal) for autonomous driving performs handover between a plurality of RSUs to maintain a seamless V2X communication connection while driving.

For example, FIGS. 7A and 7B illustrate a conventional handover method.

First, FIG. 7A illustrates a received signal condition ideal for handover when the OBU of the vehicle moves from a first service area Cell #1 of a currently connected RSU #1 to a second service area Cell #2 of another RSU #2.

At this time, the OBU of the vehicle performs the handover based on the received signal strength indication (RSSI) of the RSU #1 and the RSU #2 received in the service overlap area (i.e., handover region). For example, the OBU of the vehicle performs the handover to switch the V2X communication connection to the channel of RSU #2 when the RSSI of the currently connected Cell #1 decreases and the RSSI of Cell #2 is relatively increased to meet a threshold condition.

However, unlike the ideal received signal condition for handover above, there are shaded areas such as tunnels or buildings on the actual road, so the RSSI and communication state conditions are not always consistently proportional. That is, since the communication channel state changes from time to time even in the same position or environment, It is difficult for the OBU of the vehicle to determine the optimal handover based only on the RSSI condition and the threshold condition.

For example, FIG. 7B illustrates an actual received signal result when the vehicle passes through the tunnel, and the RSSI in the shaded section does not decrease or increase stably and is measured very irregularly.

For this reason, with only the reception strength condition of the conventional V2X communication channel, an irregular measurement RSSI may cause excessively frequent handover or communication failure due to handover delay.

In addition, even if the RSSI is strong, many actual communication errors may occur due to environmental factors such as weather, temperature, and fog. Particularly, unlike a general mobile phone, a more frequent errors may be caused in a vehicle that moves at a high speed.

In addition, the OBU of the vehicle analyzes the RSSI of signals received in real time from not only the RSU #1 and the RSU #2, but also from more RSU #Ns in real time, and selects the candidate for handover, thereby possibly causing excessive load.

The above information disclosed in this Background section is only for enhancement of understanding of the background of the disclosure, and therefore it may contain information that does not form the prior art that is already known in this country to a person of ordinary skill in the art.

### SUMMARY

A vehicle-to-everything (V2X) network handover system supporting autonomous driving of an unmanned transport vehicle may include, a plurality of road side units (RSUs) disposed in a production plant, each being configured to broadcast a WAVE Service Advertisement (WSA) message in a service area, and an on-board unit (OBU) installed in the unmanned transport vehicle to transmit and receive V2X communication data through an integrated antenna and configured to obtain vehicle position information based on global navigation satellite system (GNSS), where the OBU may be configured to execute a handover determination algorithm from the WSA message received in a service overlap area of a plurality of RSUs to select a handover target RSU based on an integrated condition combined with two or more among a distance-based condition based on a distance between each RSU and the unmanned transport vehicle, a weighted moving average condition of received signal strength indication (RSSI), and a data normal reception count condition.

The WSA message may include at least one of a unique ID, a fixed position, a data rate, a channel, and a transmission power of the RSU.

The OBU may be configured to receive positioning error correction information generated based on a fixed absolute coordinate of the RSU and correct the vehicle position information.

The OBU may be configured to calculate a distance to each RSU for the distance-based condition, and when the distance to a certain RSU is smaller than or equal to a reference distance, further configured to register the certain RSU as a handover candidate.

The OBU may be configured to, when the distance to the RSU exceeds the reference distance, exclude the RSU from the handover candidate.

The OBU may be configured to, when two or more RSUs exist as the handover candidate based on the distance-based condition, execute the handover determination algorithm.

The OBU may be configured to, when the handover determination algorithm is initiated, calculate weighted moving averages (WMA) of the RSSIs received for a preset time from the two or more RSUs of the handover candidate, and identify an RSU having highest average value.

The OBU may be configured to apply weighting processing to the WMA values based on counts of normally receiving data for a preset time from the two or more RSUs of the handover candidate, and determine an RSU having a highest weighted value as the handover target.

The OBU may be configured to generate a handover request message that may include an RSU ID of the handover target and a MAC address of the OBU and multicast the generated handover request message to the RSUs that have transmitted the WSA message.

The RSU may include, an I2I antenna connected to a wireless access in vehicular environment (WAVE)-based infra-to-infra (I2I) communication module for building a private mesh network and configured to communicate data with another RSU, a V2I antenna connected to the WAVE-based vehicle-to-Infra (V2I) communication module and configured to communicate data with the OBU, a GNSS antenna connected to a GNSS module and configured to receive a satellite signal for obtaining vehicle position information, a power supply module configured to supply electrical power to the RSU, an external interface module connected to an external maintenance equipment and configured to provide at least one of firmware upgrade, software change, and environment setting provide, and a control module configured to relay data communication between a control server and the OBU.

The GNSS module may be configured to receive at least one multi-band L1/L2 satellite signal of a GPS signal, a GLONASS signal, and a Galileo signal, and transmit a positioning error correction information utilizing real-time kinematic (RTK) to the OBU within the service area.

The control module of the handover target RSU may be configured to, upon finding its own RSU ID and a MAC address in a handover request message received from the OBU, connect a V2I wireless communication channel to the MAC address to communicate data.

The control module may be configured to update a routing table with the MAC address of the OBU and share the updated routing table to another RSU through the I2I antenna.

A vehicle-to-everything (V2X) network handover method of an on-board unit (OBU) installed in an unmanned transport vehicle may include, communicating V2X communication data with a first RSU through integrated antenna to obtain vehicle position information based on a global navigation satellite system (GNSS), receiving a WAVE Service Advertisement (WSA) message from a plurality of RSUs, calculating a distance to each RSU to register an RSU having the distance smaller than or equal to a reference distance as a handover candidate, and selecting a handover target RSU from a plurality of handover candidates by a handover determination algorithm based on an integrated condition including either of a weighted moving average condition of received signal strength indication (RSSI) and a data normal reception count condition.

The communicating V2X communication data may include, receive positioning error correction information generated based on a fixed absolute coordinate of the first RSU to correct the vehicle position information.

The receiving the WSA message from a plurality of RSUs may include analyzing the WSA message to identify at least one of a unique ID, a fixed position, a data rate, a channel, and a transmission power of a corresponding RSU.

The calculating the distance to each RSU may include, excluding, when the distance to a certain RSU exceeds the reference distance, the certain RSU from the handover candidate, and executing the handover determination algorithm when two or more RSUs exist as the handover candidate based on the distance-based condition.

The selecting the handover target RSU may include calculating weighted moving averages (WMA) of the RSSIs received for a preset time from the two or more RSUs of the handover candidate, and identify an RSU having highest average value.

The selecting the handover target RSU may further include applying weighting processing to the WMA values based on counts of normally receiving data for a preset time from the two or more RSUs of the handover candidate, and determine an RSU having a highest weighted value as the handover target.

The selecting the handover target RSU may further include, generating a handover request message that may include an RSU ID of the handover target and a MAC address of the OBU, and multicasting the generated handover request message to the RSUs that have transmitted the WSA message.

According to an exemplary form, the OBU of the unmanned transport vehicle determines handover target based on an integrated condition combined with a distance-based condition, a weighted moving average condition of the RSSI, and a data normal reception count condition, and frequent handovers and a handover delay may be prevented.

In addition, V2X communication between the OBU and the RSU may be stably maintained in the V2X network and the unmanned transport vehicle may be precisely operated due to correction of vehicle position information.

In addition, by only considering RSUs that satisfies a distance-based condition, calculation load and time in determining the handover may be reduced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically illustrates configuration of a V2X network handover system in one form of the present disclosure.

FIG. 2 illustrates communication between of an RSU and an OBU of a V2X network in one form of the present disclosure.

FIG. 3 is a block diagram schematically illustrating configuration of an RSU in one form of the present disclosure.

FIG. 4 is a flowchart schematically illustrating a V2X network handover method in one form of the present disclosure.

FIG. 5 is a flowchart illustrating a handover determination method of an OBU in one form of the present disclosure.

FIG. 6A, FIG. 6B, and FIG. 6C are graphs illustrating weighted moving averages and signal weighting processing results of the received signal strength indication for respective candidate RSUs.

FIGS. 7A and 7B illustrate a conventional handover method.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, only certain exemplary forms of the present disclosure have been shown and described, simply by way of illustration. As those skilled in the art would realize, the described forms may be modified in various different ways, all without departing from the spirit or scope of the present disclosure. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the term.

In this specification, it is to be understood that when one component is referred to as being “connected” or “coupled” to another component, it may be connected or coupled directly to the other component or be connected or coupled to the other component with a further component intervening therebetween. In this specification, it is to be understood that when one component is referred to as being “connected or coupled directly” to another component, it may be connected to or coupled to the other component without another component intervening therebetween.

The terms used herein are used only for the purpose of describing particular exemplary forms and are not intended to limit the present disclosure. Singular expressions include plural expressions unless clearly described as different meanings in the context.

It will be further understood that terms “comprise” and “have” used in the present specification specify the presence of stated features, numerals, steps, operations, components, parts, or combinations thereof, but do not preclude the presence or addition of one or more other features, numerals, steps, operations, components, parts, or combinations thereof.

Unless otherwise defined herein, all terms including technical or scientific terms used herein have the same meaning as commonly understood by one of ordinary skill in the art to which the present disclosure belongs. Terms such as those defined in a commonly used dictionary should be interpreted as being consistent with the meaning in the context of the related technology, and are not interpreted in an ideal or excessively formal meaning unless explicitly defined in the present specification.

Hereinafter, a V2X network handover system and a method thereof according to an exemplary form is described in detail with reference to the drawings.

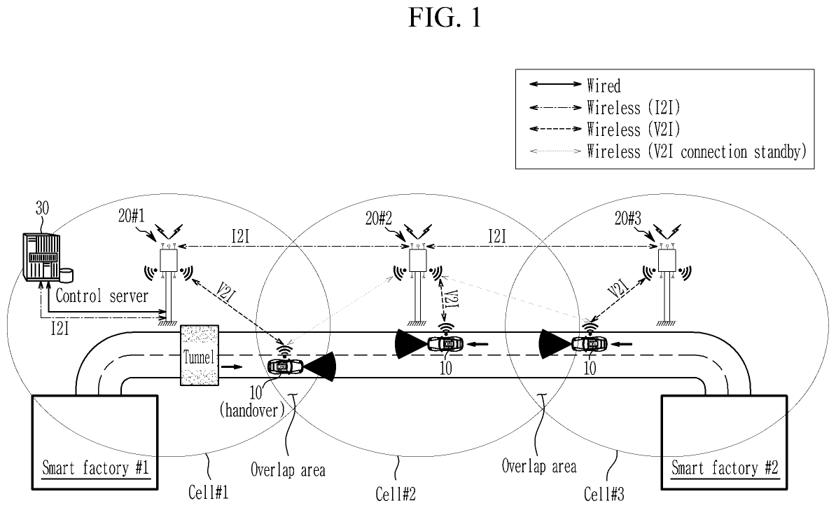

FIG. 1 schematically illustrates configuration of a V2X network handover system in some forms of the present disclosure.

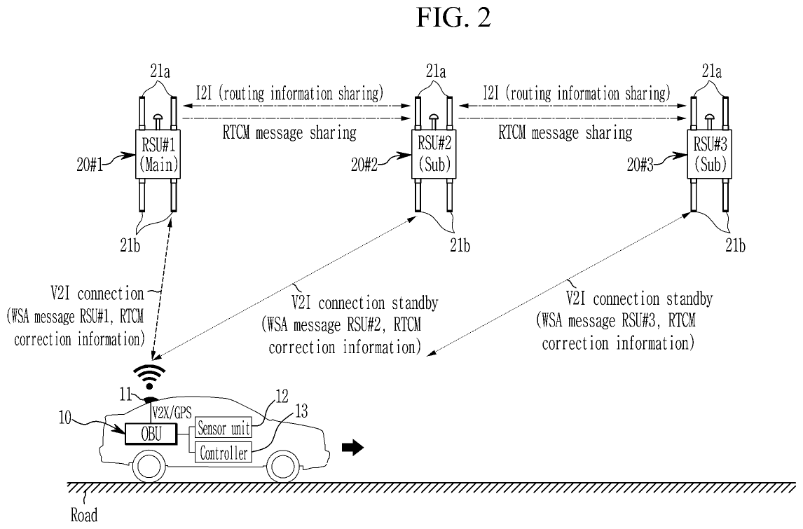

FIG. 2 illustrates communication between of an RSU and an OBU of a V2X network in some forms of the present disclosure.

Referring to FIG. 1 and FIG. 2, a V2X network handover system in some forms of the present disclosure includes an on-board unit (OBU) 10 installed on a mobility (hereinafter, called a vehicle), a road side unit (RSU) 20, and a control server 30. As shown in FIG. 1 the vehicle may be an unmanned transport vehicle operated in a production plant and configured to transport an object, such as component part of a production object. The production plant includes a plurality of small-scale smart factories and work areas and establishes a V2X mesh network. In the V2X mesh network, a plurality of RSUs 20 disposed on roads interconnection sections of the production plant are connected to the control server 30 through wireless communication.

The OBU 10 is configured to transmit and receive data through V2X communication, and control autonomous driving of the vehicle.

The OBU 10 may be configured as an OBU terminal installed in the vehicle, and the OBU terminal may include a central processing unit (CPU), a random-access memory (RAM), a read-only memory (ROM), and the like.

The OBU 10 is connected to the RSU 20 through V2X communication through an integrated antenna 11 to transmit and receive data, and may be configured to obtain vehicle position information based on global navigation satellite system (GNSS).

The OBU 10 includes a V2X communication device to perform V2X communication. The V2X communication may include vehicle-to-infrastructure (V2I) communication, vehicle-to-vehicle (V2V) communication, vehicle-to-mobile device (in other words, vehicle-to-nomadic device) (V2N) communication, and infrastructure-to-infrastructure (I2I) communication. Thus, the OBU 10 is connected to the RSU 20 through the V2X communication. In addition, the V2X communication is not limited to the listed types of communication, and may include other type of communication, such as vehicle-to-vehicle (V2V) communication.

The OBU 10 receives, from the RSU 20, positioning error correction information (for example, a radio technical commission marine (RTCM) message) generated by the RSU 20 based on a fixed absolute coordinate of the RSU 20, and correct the vehicle position information obtained through the GNSS to high precision positioning information of an error range of below 10 cm. Thus, the OBU 10 may control autonomous driving of the vehicle along a center of a lane width on a precision map, based on the high precision positioning information with corrected error.

In addition, the OBU 10 controls an overall operation of the vehicle to perform handover according to a handover determination algorithm of the V2X network of some forms of the present disclosure.

In addition, the OBU 10 may be coupled with a sensor unit 12 that monitors the surroundings for autonomous driving of the vehicle and a vehicle controller 13 that controls the running state of the vehicle.

The sensor unit 12 may include a camera, a radar, a lidar, an ultrasonic wave sensor, and a position measurement sensor such as GNSS or GPS, and the like.

The vehicle controller 13 may include an electronic transmission control unit (TCU), electronic brake control unit, an electronically controlled suspension (ECS), an electronic stability control (ESC), a motor-driven power steering (MDPS), and the like. The sensor unit 12 and the vehicle controller 13 may configured according to a known scheme, and are not described in further detail.

The plurality of RSUs 20 are disposed in the production plant to establish a V2X private network based on wireless access in vehicular environment (WAVE), and each of the RSUs 20 is configured to broadcast a WAVE Serve Advertisement (WSA) message in its service area to provide wireless communication between the OBU 10 and the control server 30. Here, it may be understood that the RSU 20 may be also called a repeater, a base station (BS), an access point (AP), a radio access station (RAS), and the like.

The RSU 20 may be installed with different types of V2X modules and connected to neighboring infrastructure facilities through infra-to-infra (I2I) wireless communication, thereby establishing a full-mesh network. In addition, the RSU 20 configures a single topology connected to the OBU 10 and vehicle-to-Infra (V2I) wireless communication, thereby constructing a V2X communication network optimized to a local private network based on wireless communication.

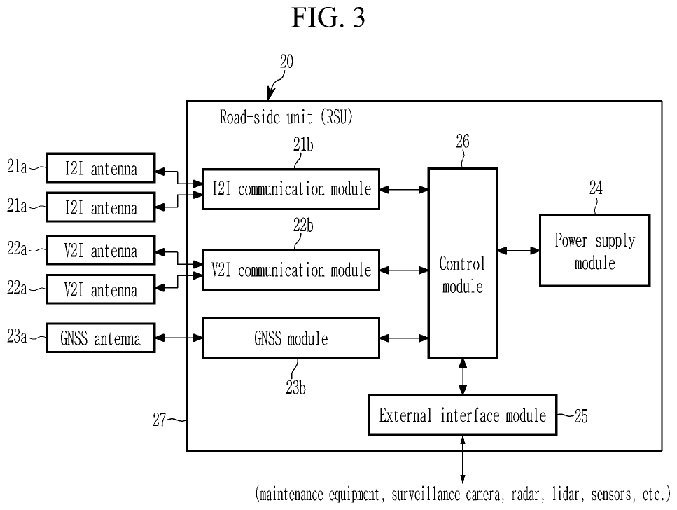

FIG. 3 is a block diagram schematically illustrating configuration of an RSU in some forms of the present disclosure.

Referring to FIG. 3, the RSU 20 in some forms of the present disclosure includes an I2I antenna 21a, an I2I communication module 21b, a V2I antenna 22a, a V2I communication module 22b, a GNSS antenna 23a, a GNSS module 23b, a power supply module 24, an external interface module 25, a control module 26, and a main body 27.

The I2I antenna 21a is connected to the WAVE-based I2I communication module 21b for building a private mesh network and configured to communicate I2I data with another RSU 20. The I2I antenna s21a may be installed on the upper portion of the main body 27, for example, in a plural quantity.

The V2I antenna 22a is connected to the WAVE-based V2I communication module 22b for building a private mesh network and configured to communicate V2I data with the OBU 10. The V2I antenna 22a may be installed on an lower portion of the main body 27, for example, in a plural quantity. This V2X communication of the RSU 20 may be different from the LTE/5G-based V2X communication method of a general communication method.

In order to prevent interference between I2I communication and V2I communication, the I2I antenna and the V2I antenna may be designed and manufactured as I2I and V2I dedicated antennas with separated channels.

The GNSS antenna 23a is connected to the GNSS module 23b and configured to receive a satellite signal for obtaining vehicle position information. The satellite signal may be a GPS signal, a GLONASS signal, a Galileo signal, and the like.

The GNSS module 23b is configured to receive a multi-band L1/L2 satellite signal through the GNSS antenna 23a, and obtain high precision position information utilizing real-time kinematic (RTK).

The OBU 10 is configured to obtain the vehicle position information based on the signals of the sensor unit 12 and control autonomous driving of the vehicle based on the vehicle position information. However, a distance error due to cosmic atmospheric ion layers, satellite orbital errors, and convective refractions may exist in the vehicle position information, so corrections may be required for safe autonomous driving.

Thus, the GNSS module 23b generates high precision RTK-GNSS-based positioning error correction information (for example, a radio technical commission marine (RTCM) message) based on a fixed absolute coordinate of the RSU 20, and provides the positioning error correction information to the OBU 10, thereby providing a positioning correction function.

For such a purpose, one RSU 20 #1 may generate the positioning error correction information (e.g., the RTCM message), and may share the RTCM message to neighboring RSUs 20 #2 and 20 #3, such that the neighboring RSUs 20 #2 and 20 #3 may provide the RTCM message to the OBU 10 of the vehicle when the vehicle enters their service areas (refer to FIG. 2).

The power supply module 24 supplies electrical power to the RSU 20. The power supply module 24 may convert a commercial AC power to a DC power appropriate for the operation of the RSU 20 and supply the converted DC power to the RSU 20. The power supply module 24 may include a supercapacitor (not shown) configured to be charged with the DC power and output the charged DC power in an emergency situation such as an electrical shut-down. In addition, the power supply module 24 may secure safety by further including an electrical leakage protection and surge protection circuit.

The external interface module 25 may include a communication terminal for at least one of CAN, USB, serial communication (for example, RS232/485), and ethernet.

The external interface module 25 is connected to an external maintenance equipment of an operator, and configured to provide firmware upgrade, software change, environment setting, and the like.

In addition, the external interface module 25 is connected to at least one detection device among surveillance cameras, radars, lidars, temperature sensors, infrared sensors and gyro sensors installed and operated together with the RSU 20 on road infrastructure such as streetlights, signal lights, and electric poles.

The control module 26 controls overall operation of the modules included in the RSU 20 in some forms of the present disclosure, and may store various programs and data in a memory.

The control module 26 is configured to relay data communication between the control server 30 and the OBU connected to the RSU 20 through V2X wireless communication.

The control module 26 is configured to broadcast a WAVE Service Advertisement (WSA) message that includes at least one of a unique RSU #ID, a fixed position, a data rate, a channel, a transmission power through the V2I communication module 22b, and thereby establishes a new V2I communication to the OBU 10 that has entered the service area (i.e., Cell) of the corresponding RSU 20.

For the new V2I communication connection, the control module 26 receives a MAC address of the OBU 10 to update a routing table with the MAC address, and shares the updated routing table with a neighboring RSU through I2I communication. This means that the control module 26 of a certain RSU 20 adds the MAC address of the new OBU 10 into its routing table, and broadcasts the V2I communication connection to the new OBD 10 to another RSU.

In another aspect, the control module 26 may receive a updated routing table from neighboring RSUs and identify MAC addresses of the OBUs 10 connected to each RSU.

Thus, the control module 26 may provide a handover for seamlessly maintaining V2I wireless communication of the OBU 10 through sharing a routing table through I2I communication with another RSUs 20.

That is, the control module 26 may control the handover according to the request of the OBU 10 entering or exiting its service area in the service overlap area with another neighboring RSU 20, and share the updated routing table added or deleted with the information of the OBU 10.

In addition, the control module 26 may receive and store validity information and encryption information of the MAC address assigned to the OBU 10 from the control server 30, and based on this, connect V2I communication only to the OBU 10 that is normally authorized. Through this, it is possible to strengthen security from external hacking/intrusion by fundamentally blocking unauthorized access of an external unauthorized terminals.

The control server 30 is a computing system that centrally controls the operation status of the RSU and the vehicle in the V2X mesh network.

The control server 30 stores vehicle operation schedule information generated according to the work process plan/schedule of the production plant, generates autonomous driving operation information for vehicle operation based on this, and transmits it to the OBU 10. The autonomous driving operation information may include a destination, a driving route, and a driving speed.

The control server 30 may collect vehicle operation status information and driving image data through the RSU 20, monitor and inspect behavior status of the vehicle moving to a destination, and control an emergency stop when an abnormality occurs.

Hereinafter, a V2X network handover method in some forms of the present disclosure is described based on the configuration of the handover system described above.

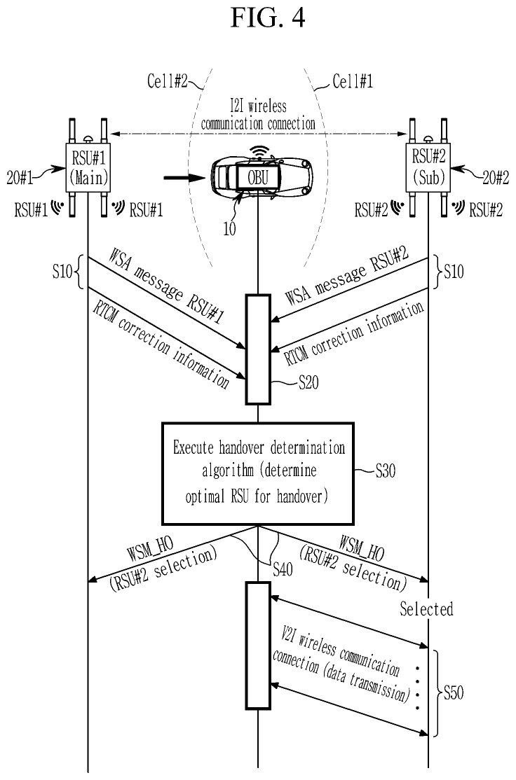

FIG. 4 is a flowchart schematically illustrating a V2X network handover method in some forms of the present disclosure.

Referring to FIG. 4, for better understanding of explanation, it is assumed that, while the OBU 10 is connected to a first RSU 20 #1, the OBU 10 enters a service overlap area between the first RSU 20 #1 and a second RSU 20 #2 (refer to FIG. 1 and FIG. 2).

At step S10, the first RSU 20 #1 broadcasts a WSA message RSU #1 and RTCM correction information in its first service area Call #1. At this time, the first RSU 20 #1 may communicate data with the OBU 10 that is currently connected through V2I communication.

At step S10, the second RSU 20 #2 broadcasts a WSA message RSU #2 and RTCM correction information for a handover connection (or, a new connection) to the OBU 10 in its second service area Call #2.

At step S20, in the service overlap area between the first service area Call #1 and the second service area Call #2, the OBU 10 receives the WSA message and the RTCM correction information transmitted from the first and second RSUs 20 #1 and 20 #2. In addition, the OBU 10 may further receive the WSA message and the RTCM correction information transmitted from at least one other RSU 20.

At step S30, the OBU 10 executes a handover determination algorithm to select a handover target RSU. Here, in the handover determination algorithm, an integrated condition combined with two or more among a distance-based condition based on a distance between each RSU and the vehicle, a received signal strength indication (RSSI) condition, and a data normal reception count condition is used to select the handover target RSU. The handover determination algorithm will be later described in further detail.

At this time, when the second RSU 20 #2 is selected as the handover target, at step S40, the OBU 10 generates a handover request message (e.g., WAVE Service Message handover, WSM_HO) that includes an RSU ID RSU #2 of the selected second RSU 20 #2 and the MAC address of the OBU 10, and transmits the handover request message to the RSU 20. The vehicle terminal 10 may transmit, for example, by multicasting, the handover request message to respective RSUs 20 that have transmitted the WSA message.

At step S50, when the second RSU 20 #2 confirms that its own RSU ID RSU #2 are included in the handover request message received from the OBU 10, the second RSU 20 #2 connects (i.e., allocates) V2I wireless communication channel to the MAC address of the OBU 10 and communicates data (for example, process wave service message (PrcsWSM) data) with the OBU 10. At this time, the second RSU 20 #2 may update the routing table with the MAC address of the OBU 10 and share the updated routing table with other RSUs.

On the other hand, the first RSU 20 #1 receives the WSM message and thereby finds that handover request is made with respect to the OBU 10 of the MAC address currently connected to the first RSU 20 #1. Thereafter, upon receiving routing table sharing information from the second RSU 20 #2, the first RSU 20 #1 may identify that the handover is finished and may disconnect the channel currently connected to the OBU 10.

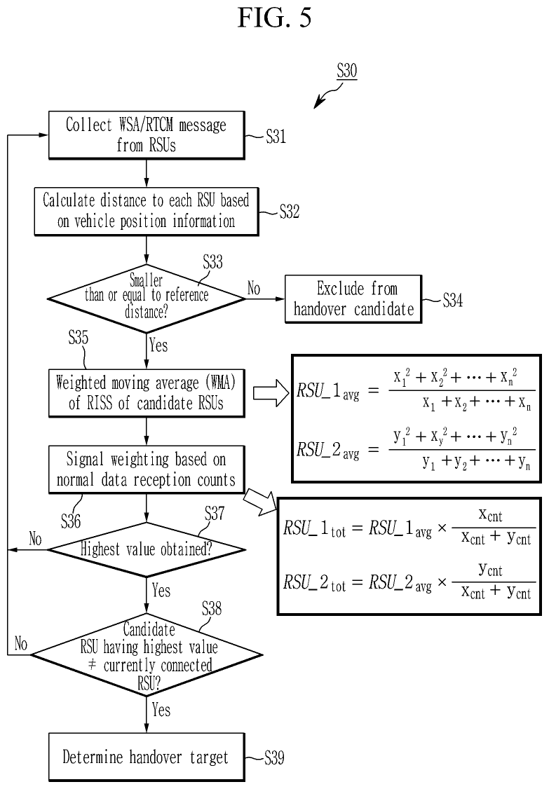

Meanwhile, FIG. 5 is a flowchart illustrating a handover determination method of an OBU in some forms of the present disclosure.

FIG. 5 shows detailed processes of the handover determination algorithm executed by the OBU 10 at the step S30 of FIG. 4.

At step S31, the OBU 10 scans received signals for a preset time, and collects the WSA message and the RTCM correction information from each in a plurality of RSUs including the first RSU 20 #1 and the second RSU 20 #2. The OBU 10 analyzes the WSA message, and identifies at least one (for example, all) of a unique ID, a fixed position, a data rate, a channel, and a transmission power of a corresponding RSU.

At step S32, the OBU 10 calculates a distance to each RSU 20 based on the vehicle position information.

At step S33, the OBU 10 determines whether the distance to each RSU 20 is smaller than or equal to a reference distance.

When the calculated distance to a certain RSU is smaller than or equal to the reference distance (S33—Yes), the OBU 10 registers the certain RSU as a handover candidate. On the other hand, at step S34, when the distance to the RSU exceeds reference distance (S33—No), the OBU 10 excludes the RSU from the handover candidate. For example, the reference distance may be set smaller than a preset radius of the service area of the RSU 20. At this time, the OBU 10 may select the handover candidates of the first and second RSUs 20 #1 and 20 #2 corresponding to valid service areas Call #1 and Call #2, and may exclude other RSUs, thereby reducing operational load and time.

In addition, when the first RSU 20 #1 that is currently connected exists as only one handover candidate based on the reference distance condition, there is no possibility of handover and therefore the OBU 10 may not execute the handover determination algorithm.

In other words, when two or more RSUs, RSUs 20 #1 and 20 #2 in this example, exist as the handover candidate based on distance-based condition, the OBU 10 executes the handover determination algorithm.

At step S35, when the handover determination algorithm is initiated, the OBU 10 calculates weighted moving averages (WMA) of received signal strength indication (RSSI) of signals received for a preset time from a plurality of candidate RSUs 20 #1 and 20 #2. It is notable that FIG. 5 shows detailed calculation formula for the weighted moving average, where Xₖ indicates RSSI of k-th signal received from the first candidate RSU 20 #1, Yₖ indicates RSSI of k-th signal received from the second candidate RSU 20 #2, k is an integer in a range of 1 to n, and n is the number of RSUs.

In addition, at step S36, the OBU 10 applies signal weighting processing to the weighted moving average (WMA) values based on counts of normally receiving data for the preset time from the candidate RSUs 20 #1 and 20 #2. It is notable that FIG. 5 shows detailed calculation formula for the signal weighting processing, where X_{cnt} indicates the count of normally receiving data for the preset time from the candidate RSU 20 #1, and Y_{cnt} indicates the count of normally receiving data for the preset time from the candidate RSU 20 #1.

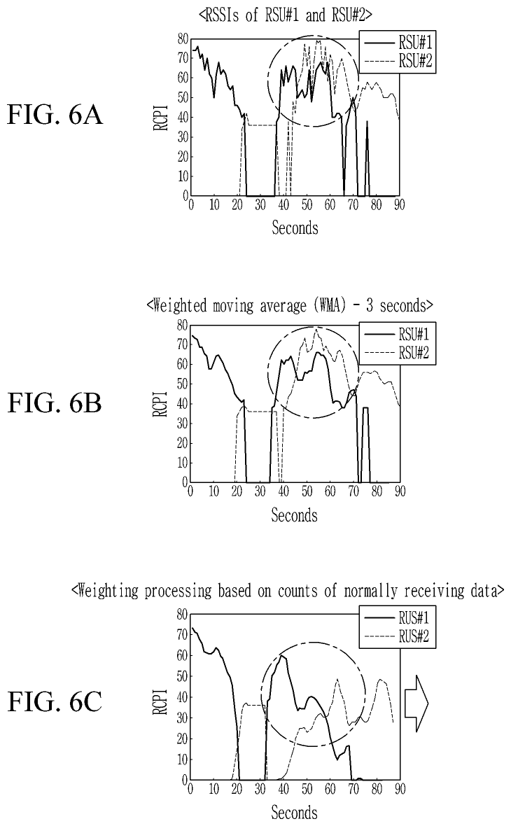

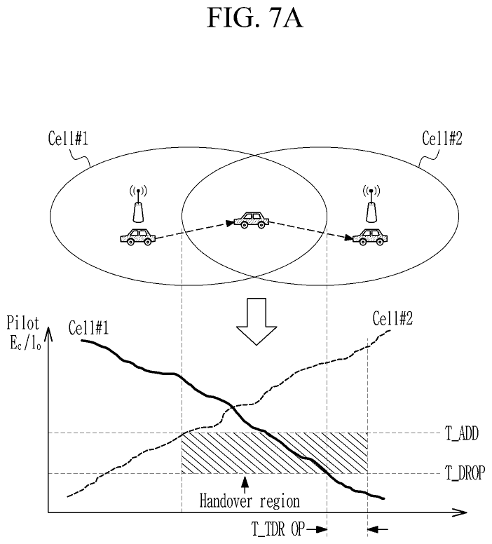

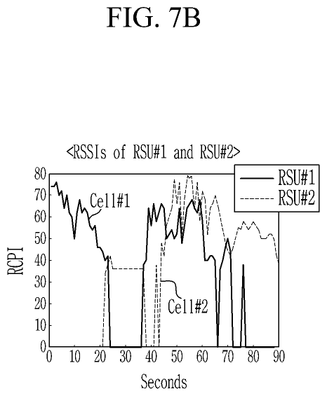

FIG. 6A, FIG. 6B, and FIG. 6C are graphs illustrating weighted moving averages and signal weighting processing results of the received signal strength indication for respective candidate RSUs.

First, referring to FIG. 6A, when the handover is performed according to a conventional received signal strength indication (RSSI) condition, the RSU connected to the OBU may be frequently changed or a handover delay may be delayed, due to fluctuations in the service overlap area.

Referring to FIG. 6B, the OBU 10 applies the weighted moving average to the RSSI of the WSA message received from each of the RSU 20 #1 and 20 #2 to obtain a first average value RSU_1_{avg} and a second average value RSU_2_{avg} (refer to the step S35 in FIG. 5). FIG. 6B shows that the weighted moving average value for the second RSU 20 #2 is higher than the weighted moving average value for the first RSU 20 #1, and thus, the OBU 10 may identify the second RSU 20 #2 having the highest average value as the handover target.

In addition, the OBU 10 may perform further consideration in determining the handover target. Referring to FIG. 6C, the OBU 10 applies the weighting process to the first average value RSU_1_{avg} and the second average value RSU_2_{avg} based on counts of normally receiving data for a preset time from the candidate RSUs 20 #1 and 20 #2 (refer to the step S36 in FIG. 5). FIG. 6C shows that the weighting processed value for the first RSU 20 #1 steeply decays while the weighting processed value for the first RSU 20 #1 steeply rises. Therefore, the OBU 10 may identify the second RSU having the highest value as the handover target, more clearly.

Referring back to FIG. 5, at step S337, the OBU 10 determines whether the highest weighted value at the step S36 is obtained from the candidate RSUs.

It may be notable that, as described above, depending on implementation, the step S36 may not be compulsory, and the OBU 10 may determine the candidate RSU 20 having the highest average value identified at the step S35 as the handover target. In this case, at the step S37, the OBU 10 determines whether the highest average value at the step S35 is obtained from the candidate RSUs.

When the highest value is not obtained (S37—No), as in the case that there is no other RSUs for handover, the OBU 10 maintains the current connection status without an attempt for the handover, and the process returns to the step S31.

On the other hand, when the highest value is obtained (S37—Yes), the OBU 10 determines, at step S38, whether the candidate RSU having the highest value is not equal to the currently connected RSU.

When the candidate RSU having the highest value is not equal to the currently connected RSU (S38—Yes), the OBU 10 determines the RSU having the highest value as the handover target, at step S39,

At this time, the OBU 10 may generate a handover request message (WSM_HO) indicating the second RSU 20 #2 having the highest value as the handover target, and multicast the generated handover request message to the RSUs 20.

Meanwhile, when the RSU having the highest value is equal to the currently connected first RSU 20 #1 (S38—No), the OBU 10 maintains the current connection status without an attempt for the handover, and the process returns to the step S31.

In the above, an exemplary form has been described, but the present disclosure is not limited to the above exemplary forms, and other various modifications are possible.

For example, for convenience of description, it has been described that the OBU 10 performs both the steps of S35 for WMA processing of the RSSI and S36 for signal weighting processing based on the count of normally receiving data.

However, depending on forms of the present disclosure, either of the steps S35 and S36 may be omitted such that only one of the steps S35 and S36 is performed to obtain the highest value.

In addition, it may be understood that the above form may be applicable to establish a new V2I communication connection rather than a handover situation. Thus, in this case, the term handover may be interpreted as establishment of a new V2I communication connection.

For example, prior to the step S31 in FIG. 5, when the OBU 10 is turned on by starting of the vehicle, the OBU 10 receives the WSA message and the RTCM correction information from at least one RSU 20. Thus, in this case, the OBU 10 may connect the new V2I communication, based on an integrated condition combined with a distance-based condition based on a distance between each RSU and the unmanned transport vehicle, a weighted moving average condition of received signal strength indication (RSSI), and a data normal reception count condition.

In addition, a V2X network handover system and a method thereof in some forms of the present disclosure may be applicable to a public V2X network as well as a private V2X network.

As such, in some forms of the present disclosure, the OBU of the unmanned transport vehicle determines handover target based on an integrated condition combined with a distance-based condition, a weighted moving average condition of the RSSI, and a data normal reception count condition, and frequent handovers and a handover delay may be prevented.

In addition, V2X communication between the OBU and the RSU may be stably maintained in the V2X network and the unmanned transport vehicle may be precisely operated due to correction of vehicle position information.

In addition, by only considering RSUs that satisfies a distance-based condition, calculation load and time in determining the handover may be reduced.

The exemplary forms of the present disclosure described above are not only implemented by the apparatus and the method, but may be implemented by a program for realizing functions corresponding to the configuration of the forms of the present disclosure or a recording medium on which the program is recorded.

While this disclosure has been described in connection with what is presently considered to be practical exemplary forms, it is to be understood that the disclosure is not limited to the disclosed forms. On the contrary, it is intended to cover various modifications and equivalent arrangements included within the spirit and scope of the appended claims.

### DESCRIPTION OF SYMBOLS

| | |
|---|---|
| 10: OBU (OBU) | 11: multi antenna |
| 12: sensor unit | 13: vehicle controller |
| 20: RSU | 21a: I2I antenna |
| 21b: I2I communication module | 22a: V2I antenna |
| 22b: V2I communication module | 23a: GNSS antenna |
| 23b: GNSS module | 24: power supply module |
| 25: external interface module | 26: control module |
| 27: main body | 30: control server |

What is claimed is:

1. A vehicle-to-everything (V2X) network handover system supporting autonomous driving of an unmanned transport vehicle, the system comprising:
a plurality of road side units (RSUs) disposed in a production plant, wherein each RSU of the plurality of RSUs is configured to broadcast a WAVE Service Advertisement (WSA) message in a service area; and
an on-board unit (OBU) installed in the unmanned transport vehicle, wherein the OBU is configured to:
transmit and receive V2X communication data through an integrated antenna; obtain vehicle position information based on global navigation satellite system (GNSS);
execute a handover determination algorithm from the WSA message; and
select a handover target RSU based on an integrated condition combined with at least two distance-based conditions, a distance between each RSU and the unmanned transport vehicle, a weighted moving average condition of received signal strength indication (RSSI), and a data normal reception count condition.

2. The V2X network handover system of claim 1, wherein the WSA message comprises at least one of a unique ID, a fixed position, a data rate, a channel, or a transmission power of the RSU.

3. The V2X network handover system of claim 1, wherein the OBU is configured to:
receive positioning error correction information generated based on a fixed absolute coordinate of the RSU; and
correct the vehicle position information.

4. The V2X network handover system of claim 1, wherein the OBU is configured to:
calculate a distance to each RSU for the distance-based condition; and
when a distance to a predetermined RSU is less than or equal to a reference distance, register the predetermined RSU as a handover candidate.

5. The V2X network handover system of claim 4, wherein the OBU is configured to:
when the distance to the predetermined RSU is greater than the reference distance, exclude the predetermined RSU from the handover candidate.

6. The V2X network handover system of claim 4, wherein the OBU is configured to:
when at least two RSUs are the handover candidate based on the distance-based condition, execute the handover determination algorithm.

7. The V2X network handover system of claim 6, wherein the OBU is configured to:
when the handover determination algorithm is executed, calculate weighted moving averages (WMA) of the RSSIs that has been received for a predetermined amount of time from the at least two RSUs of the handover candidate; and
identify an RSU of the plurality of RSUs having a highest average value.

8. The V2X network handover system of claim 7, wherein the OBU is configured to:
apply weighting processing to the WMA values based on counts of normally receiving data for a predetermined amount of time from at least two RSUs of the handover candidate; and
determine that an RSU of the plurality of RSUs having a highest weighted value is the handover target.

9. The V2X network handover system of claim 1, wherein the OBU is configured to:
generate a handover request message that includes an RSU ID of the handover target and a MAC address of the OBU; and
multicast the generated handover request message to the plurality of RSUs that have transmitted the WSA message.

10. The V2X network handover system of claim 1, wherein each RSU comprises:
an I2I antenna connected to a wireless access in vehicular environment (WAVE)-based infra-to-infra (I2I) communication module for building a private mesh network and configured to communicate data with a different RSU;
a V2I antenna connected to the WAVE-based vehicle-to-Infra (V2I) communication module and configured to communicate data with the OBU;
a GNSS antenna connected to a GNSS module and configured to receive a satellite signal for obtaining vehicle position information;
a power supply module configured to supply electrical power to the RSU;
an external interface module connected to an external maintenance equipment and configured to provide at least one of firmware upgrade, software change, or environment setting; and
a control module configured to relay data communication between a control server and the OBU.

11. The V2X network handover system of claim 10, wherein the GNSS module is configured to:
receive at least one multi-band L1/L2 satellite signal of a GPS signal, a GLONASS signal, or a Galileo signal; and
transmit, to the OBU, a positioning error correction information utilizing real-time kinematic (RTK) within the service area.

12. The V2X network handover system of claim 10, wherein the control module is configured to:
when its own RSU ID is identified and a MAC address in a handover request message is received from the OBU, connect a V2I wireless communication channel to the MAC address to communicate data.

13. The V2X network handover system of claim 12, wherein the control module is configured to:
update a routing table with the MAC address; and
share the updated routing table to the different RSU through the I2I antenna.

14. A vehicle-to-everything (V2X) network handover method of an on-board unit (OBU) installed in an unmanned transport vehicle, the method comprising:
communicating V2X communication data with a first RSU of a plurality of RSUs through integrated antenna to obtain vehicle position information based on a global navigation satellite system (GNSS);
receiving a WAVE Service Advertisement (WSA) message from the plurality of RSUs;
calculating a distance to each RSU of the plurality of RSUs to register an RSU having a distance less than or equal to a reference distance as a handover candidate; and
selecting a handover target RSU from a plurality of handover candidates by a handover determination algorithm based on an integrated condition including a weighted moving average condition of received signal strength indication (RSSI) and a data normal reception count condition.

15. The V2X network handover method of claim 14, wherein communicating the V2X communication data comprises:
receiving positioning error correction information generated based on a fixed absolute coordinate of the first RSU to correct the vehicle position information.

16. The V2X network handover method of claim 14, wherein receiving the WSA message comprises:
analyzing the WSA message to identify at least one of a unique ID, a fixed position, a data rate, a channel, or a transmission power of a corresponding RSU.

17. The V2X network handover method of claim 14, wherein calculating the distance to each RSU comprises:
when a distance to a predetermined RSU is greater than the reference distance, excluding the predetermined RSU from the handover candidate; and
when at least two RSUs exist as the handover candidate based on the distance-based condition, executing the handover determination algorithm.

18. The V2X network handover method of claim 14, wherein selecting the handover target RSU comprises:
calculating weighted moving averages (WMA) of the RSSIs received for a predetermined amount of time from at least two RSUs; and
identifying an RSU of the plurality of RSUs having a highest average value.

19. The V2X network handover method of claim 18, wherein selecting the handover target RSU further comprises:
applying weighting processing to the WMA values based on counts of normally receiving data for a predetermined amount of time from at least two RSUs; and
determining that the RSU of the plurality of RSUs having the highest weighted value is the handover target.

20. The V2X network handover method of claim 19, wherein selecting the handover target RSU further comprises:
generating a handover request message that includes an RSU ID of the handover target and a MAC address of the OBU; and
multicasting the generated handover request message to the plurality of RSUs that has transmitted the WSA message.
